(19) United States
(12) Patent Application Publication
(10) Pub. No.: US 2007/0281614 A1
(43) Pub. Date: Dec. 6, 2007

(54) METHOD AND APPARATUS FOR DUAL MODE COMMUNICATIONS

(75) Inventors: MANUEL OLIVER, SCOTTSDALE, AZ (US); RICHARD MARTIN POVENMIRE, SCOTTSDALE, AZ (US); JOHN BROCK PRESTON, PLANTATION, FL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/421,513

(22) Filed: Jun. 1, 2006

(51) Int. Cl. H04B 7/00; H04B 1/00; H04B 1/38

(52) U.S. Cl. 455/41.2; 455/557; 455/68

(57) ABSTRACT

A first communication device configured for communications with a second communications device, and related system and method of operation, are disclosed. In at least some embodiments, the first device includes a first transceiver allowing the first device to send and receive electromagnetic communication signals, and a second transceiver allowing the first device to send and receive capacitive communication signals. The first device includes a control device coupled to the first and second transceivers, whereby the first device is configured for achieving both electromagnetic communications and capacitive communications, respectively, with the second device. In some further embodiments, the first device operates normally in a capacitive mode of communication and only switches to an electromagnetic mode of communication when the capacitive mode is unavailable or inadequate, and/or the first device only communicates with other devices in an electromagnetic mode if those other devices are also capable of communication via the capacitive mode.

### FIELD OF THE INVENTION

The present invention relates to communication systems, particularly wireless communication systems.

### BACKGROUND OF THE INVENTION

Wireless communication devices such as cellular telephones, pagers, personal digital assistants, and other handheld devices are ubiquitous in the modern world. Among these devices are a variety of short-range wireless communication devices, such as devices equipped for Bluetooth communications, for example, headsets such as mono-headsets or stereo headsets and wrist wearable communication devices. Such communication devices are often capable of forming and communicating by way of personal area networks (PANs).

Notwithstanding the usefulness and ubiquity of wireless communication devices, including short-range wireless communication devices, such devices are somewhat limited in their capabilities insofar as the devices typically have fairly large, continuous power requirements. More particularly, wireless communication devices typically draw power continuously even while in a standby mode, and consequently such devices are usually incapable of having more than about a 100-hour operational life without recharging. Yet in many circumstances it would be desirable if the life of a wireless communication device was much longer than this, for example, up to 1 year.

Additionally, as the number of wireless communication devices being used increases, the number of potential interactions among these devices also increases, which in some cases can lead to non-ideal behavior. For example, when a user of a given Bluetooth device enters a crowded environment in which there are other Bluetooth users, the given Bluetooth device typically will operate to survey the environment to identify all other Bluetooth devices that are present with which it could potentially communicate. However, such operation can be undesirable when the number of devices present is large, for example, because the discovery of other devices can slow the overall operation of the given Bluetooth device. This is especially the case if the primary goal of the user of the given Bluetooth device is merely to achieve communications among the user's own personal Bluetooth devices (e.g., between the user's phone and headset).

For at least these reasons, therefore, it would be advantageous if an improved system and method for wireless communications could be developed. More particularly, in at least some embodiments, it would be advantageous if an improved wireless communication device, and/or system/method implementing such device, could be developed in which lower amounts of power were utilized. Also, in at least some embodiments, it would be advantageous if an improved wireless communication device, and/or system/method implementing such device, could be developed that was capable of restricting its operation so as to only communicate with other devices being operated by the same user.

### BRIEF SUMMARY OF THE INVENTION

The present inventors have recognized that wireless communication devices capable of communication via one or more electromagnetic wireless modes of communication could also be configured so as to be capable of communication in a capacitive wireless mode (or modes) of communication in a manner that would address one or more of the above-described limitations. In some such embodiments, such dual mode wireless communication devices could be operated normally in a capacitive wireless mode of communication rather than an electromagnetic wireless mode of communication, and operated in an electromagnetic wireless mode of communication only when the capacitive wireless mode of communication was unavailable or inadequate for conducting the desired communications, so as to conserve power of the devices. Also, in some such embodiments, the wireless communication device could be configured to identify other wireless devices that were capable of both electromagnetic and capacitive wireless communications, and limit its electromagnetic wireless communications to only those devices that were capable of both types of communications.

In at least some embodiments, the present invention relates to a first communication device configured for communications with a second communications device. The first communication device includes a first transceiver allowing the first communication device to send and receive electromagnetic communication signals, and a second transceiver allowing the first communication device to send and receive capacitive communication signals. The first communication device additionally includes a control device coupled to the first and second transceivers, whereby the first communication device is configured for achieving both electromagnetic communications and capacitive communications, respectively, with the second communication device.

Additionally, in at least some embodiments, the present invention relates to a method of communicating. The method includes transmitting a capacitive communication signal from a first communication device to a second communication device, and transmitting an electromagnetic communication signal from either the first communication device to the second communication device or from the second communication device to the first communication device. The transmitting of the capacitive communication signal precedes, occurs simultaneously with, or occurs after the transmitting of the electromagnetic communication signal.

Further, in at least some embodiments, the present invention relates to a method of operating a first communication device. The method includes operating the first communication device in a first mode such that the first communication device is capable of conducting communications with a second communication device by way of a capacitive communication link, and operating the first communication device in a second mode such that the first communication device is capable of conducting communications with the second communication device by way of a RF wireless communication link. The first communication device normally operates in the first mode so that a power dissipation associated with the operating in the second mode is limited.

### BRIEF DESCRIPTION OF THE DRAWINGS

FIG. 1 is a schematic illustration of an exemplary group of wireless communication devices, at least some of which are capable of intercommunications by way of each of an electromagnetic wireless communication network and a capacitive wireless communication network;

FIG. 2 is a block diagram showing exemplary components of one of the wireless communication devices of FIG. 1; and

FIGS. 3-5 are three flow charts showing various exemplary steps of operation of one or more of the wireless communication devices of FIG. 1.

### DETAILED DESCRIPTION OF THE INVENTION

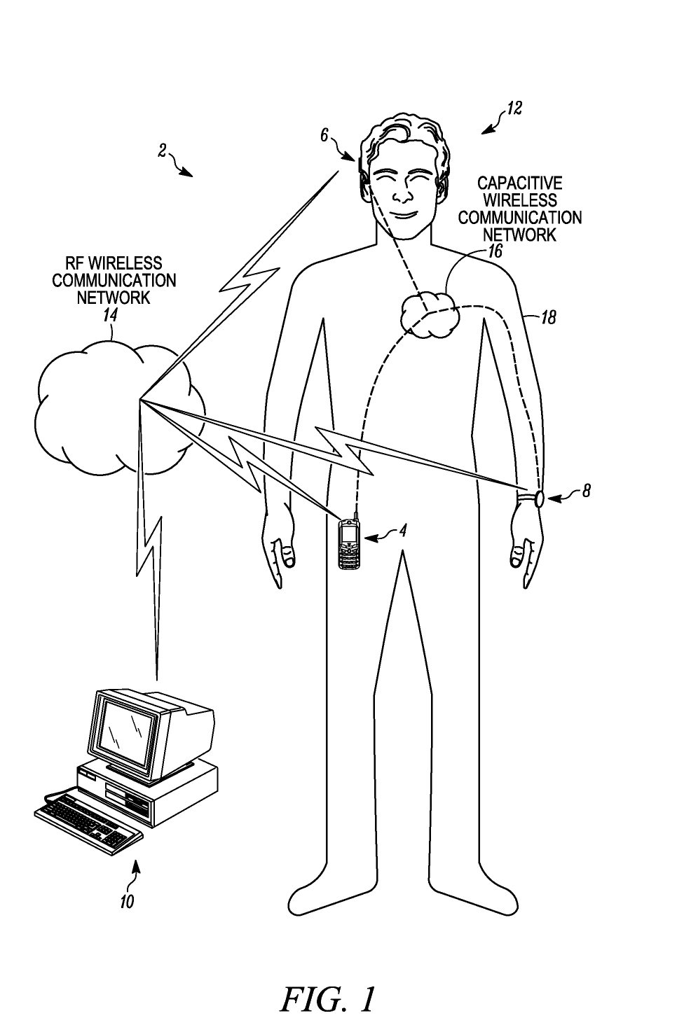

Referring to FIG. 1, an improved wireless communication system 2 in accordance with at least some embodiments of the present invention is shown. The wireless communication system 2 includes multiple wireless communication devices, namely, a cellular telephone 4, a mono-headset 6, a wrist wearable communication device 8, and a wireless-enabled personal computer 10. Three of the devices shown, namely, the cellular telephone 4, the mono-headset 6 and the wrist wearable communication device 8 are in the possession of, and carried by, a human person 12. The personal computer 10, depending upon the embodiment or operational circumstance, can be also in the possession of and be in contact with (or even possibly be carried by) the person 12. However, in the present embodiment it is intended that the personal computer 10 be a device that is not in contact with, and is somewhat remote from, the person 12.

Further as shown, the wireless communication devices 4, 6, 8 and 10 each are capable of communicating via a RF wireless communication protocol with one another (and possibly with other devices, not shown). When any two or more of the wireless communications devices 4, 6, 8 and 10 are in communication with one another by way of the RF wireless communications protocol, the communicating devices form a RF wireless communication network 14 as shown. The RF (radio frequency) wireless communication network 14 is intended to be representative of any one or more communications links connecting any two or more wireless communication devices, where communication by way of the link(s) occurs by way of any one or more of a variety of different types of RF wireless communication protocols.

For example, the wireless communication devices 4, 6, 8 and 10 forming the network 14 could be configured for communication by way of the Bluetooth communication protocol or the Zigbee communication protocol. Alternatively, the wireless communication devices could be configured for communication in accordance with an ultra-wide band communication protocol. Still, in additional circumstances, one or more of the wireless communication devices could be configured for communication via more than one wireless communication protocol. For example, the cellular telephone 4 could be configured for communication by way of the Bluetooth protocol and also be capable of communication via a conventional cellular communication protocol (e.g., CDMA, CDMA2000, GSM, etc.). Thus, the RF wireless communication network 14 is intended to be representative of multiple RF wireless communication networks, where one of the networks involves Bluetooth and another of the networks involves communication by way of some other RF wireless communication protocol.

In at least some embodiments of the present invention, the RF wireless communication network 14 is intended to be representative of a personal area network (PAN) allowing for communication between devices that are positioned within several meters of one another (e.g., approximately 10 meters in the case of Bluetooth communications and approximately 30 meters in the case of Zigbee communications). The wireless communication devices, when operated in such a manner, typically would have relatively high transmit power (and/or current) requirements, for example, on the order of 30-40 mA. Further, although FIG. 1 shows the network 14 to be a RF wireless communication network, the present invention is equally intended to encompass embodiments in which another type of electromagnetic wireless communication network is used instead of, or in addition to, a RF wireless communication network (e.g., a microwave wireless communication network).

Still referring to FIG. 1, at least three of the wireless communication devices shown, namely, the cellular telephone 4, the mono-headset 6 and the wrist wearable communication device 8, are further capable of communication by way of a second wireless communication technology that is a capacitive wireless communication technology. More particularly, when two or more of the devices 4, 6 and 8 are communicating with one another by way of one or more links using the capacitive wireless communication technology, a capacitive wireless communication network 16 is formed. Further as shown, the capacitive wireless communication network 16 relies upon signals being transmitted via the body of the person 12 and, more particularly, by way of skin 18 of the person 12. Typically, in order for one of the devices 4, 6 and 8 to communicate with another one of those devices by way of the capacitive wireless communication technology so as to form the network 16, the two communicating devices must each be in either direct or near direct contact with the skin 18 of the person 12 (e.g., positioned 0-2 cm away from the skin) or at least within a short distance therefrom (e.g., within a range of up to one meter away from the person). Although a variety of capacitive wireless communication technologies of this type are available or presently being developed, one exemplary capacitive wireless communication technology is the Skinplex communication technology available from Ident Technology AG of Wesling, Germany.

Communication among the devices 4, 6 and 8 by way of the capacitive wireless communication network 16 requires significantly less power/current than communication via the RF wireless communication network 14. While as discussed above the wireless communication devices 4, 6, 8 and 10 each can typically require 30-40 mA of current draw when communicating via the RF wireless communication network 14, even when operating in a standby mode, the devices 4, 6 and 8 only draw approximately 0.2 mA when communicating via the capacitive wireless communication network. In the future, the current draw associated with communicating via a capacitive wireless communication network could be much less, e.g., as little as 0.005 mA or less. Thus, communication among the devices 4, 6 and 8 by way of the capacitive wireless communication network 16 is much less power intensive than communication among those devices (and potentially other devices such as the personal computer 10) by way of the RF wireless communication network 14.

Thus, the system 2 of FIG. 1 is an exemplary communication system having multiple wireless communication devices that are capable of two manners or modes of communication, namely, a RF wireless communication mode and a capacitive wireless communication mode. In the embodiment of FIG. 1, more specifically, it is the wireless communication devices 4, 6 and 8 that are capable of both modes of communication, while the personal computer 10 is only capable of the RF wireless communication mode of communication (however, in other embodiments, the personal computer 10 could also be capable of communicating in both modes). At the same time, FIG. 1 is intended to be representative of any collection of more than one wireless communication device (e.g., as few as two devices) that are capable of communicating with one another by way of both a RF (or other electromagnetic) wireless communication technique and a capacitive wireless communication technique. In some such embodiments, like the embodiment of FIG. 1, only a subset of the total number of communicating devices will be capable of communicating in both modes.

Further, while FIG. 1 shows the cellular telephone 4, the mono-headset 6, the wrist wearable communication device 8 and the personal computer 10, these communication devices are only intended to be exemplary. The present invention is intended to encompass communication systems involving two or more wireless communication devices that can be any of a variety of different types of wireless communication devices including, for example, a variety of types of telephones including not just cellular telephones but also other types of wireless telephones, walkie-talkies, a variety of types of wireless-enabled computers including desktop, notebook or laptop computers, a variety of personal digital assistants, handheld computers or other handheld devices, intercom systems, pagers, wireless devices embedded within eyewear such as glasses, wireless devices embedded within garments, various types of headsets, stereos (including car stereos), speakers, and a variety of other devices.

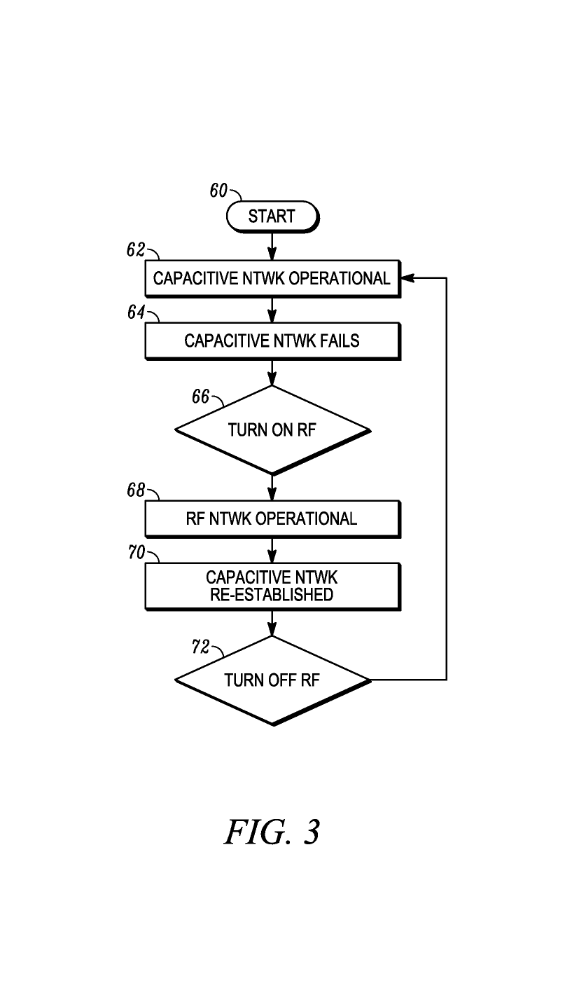

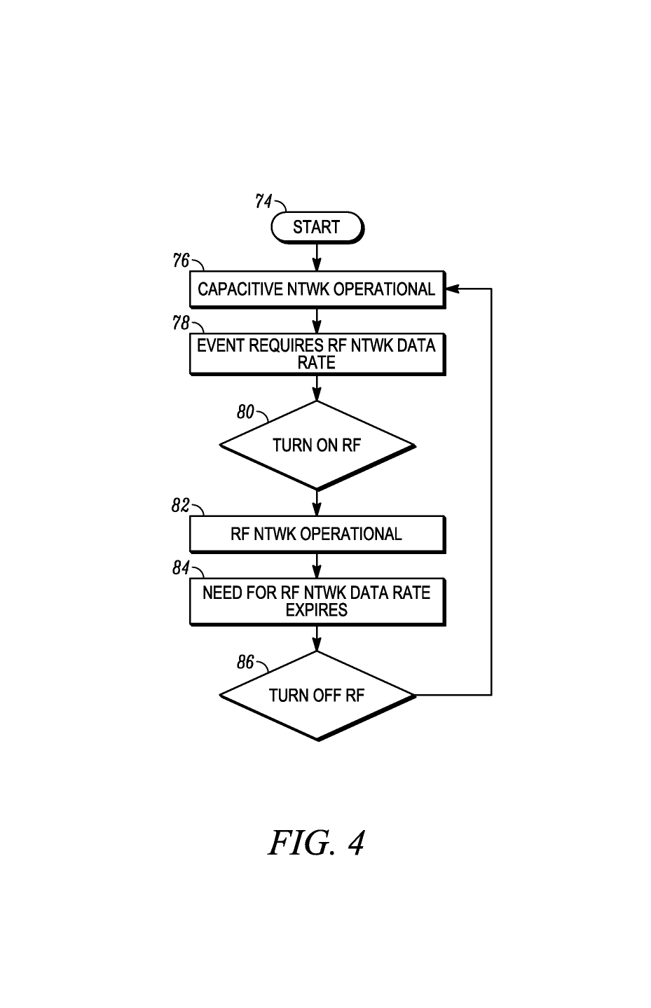

As will be described in further detail below with reference to FIGS. 3 and 4, in some embodiments, the dual mode wireless communication devices (e.g., the devices 4, 6 and 8 of FIG. 1) are configured to operate such that the devices communicate (or are ready for communicating) in only one of the two modes at any given time. That is, at certain times the wireless communication devices only communicate via the RF wireless communication network 14 and at other times the devices only communicate via the capacitive wireless communication network 16. However, the present invention is also intended to encompass embodiments where both modes of communication are used or available at the same time, as well as embodiments where communication via one of the modes is always occurring (or available) while communication via the other mode only occurs (or is available) at a limited time or times.

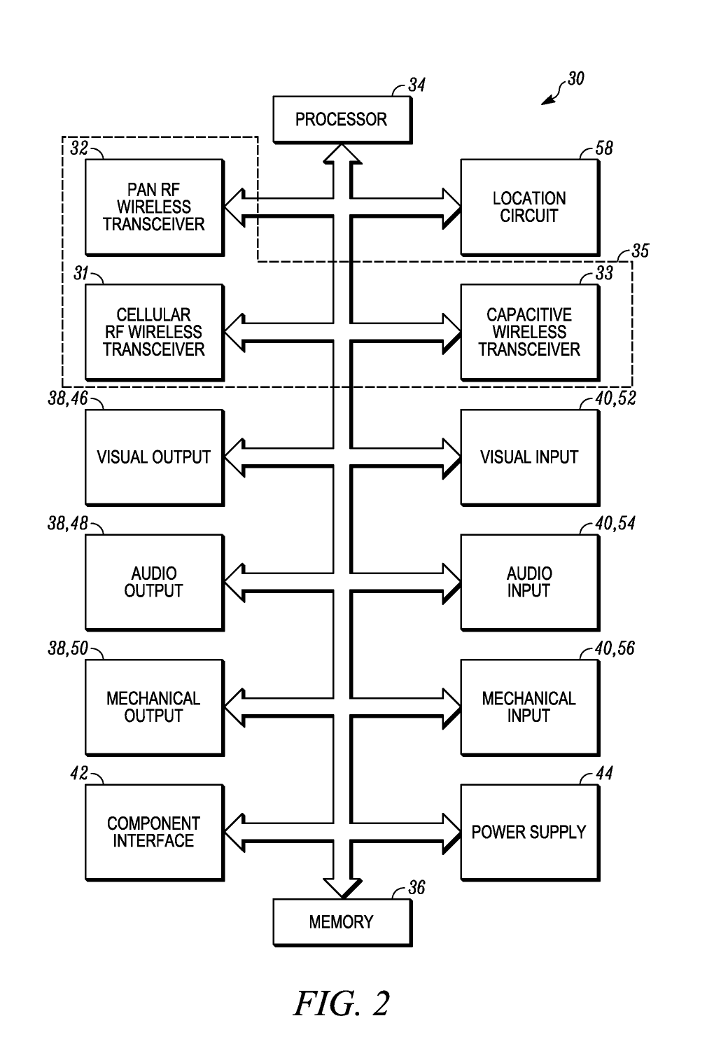

Turning to FIG. 2, there is provided a block diagram illustrating exemplary internal components 30 of the cellular telephone 4 of FIG. 1. Although particularly intended to be representative of the internal components of the cellular telephone 4, the block diagram likewise is possibly representative (depending on the embodiment) of the internal components of the mono-headset 6 and the wrist wearable communication device 8 that are also capable of two modes of wireless communication, and is generally intended to be representative of the internal components of other wireless or mobile communication devices capable of dual mode communications. It will further be understood that the wireless-enabled computer 10 shown in FIG. 1 also has or can have many or all of the same (or similar) components as are shown in FIG. 2 as being part of the cellular telephone 4 and as are described in further detail below, albeit to the extent that in the embodiment of FIG. 1 the computer is not configured for communications via the capacitive wireless communication network 16, the computer need not include the components specifically allowing for such communications.

As shown in FIG. 2, the internal components 30 of the cellular telephone 4 include a processor 34, several wireless transceivers 35, a memory portion 36, one or more output devices 38, and one or more input devices 40. The processor 34 can be any of a variety of different processing devices including, for example, a microprocessor. In at least some embodiments, the internal components 30 include a user interface (not shown) that comprises one or more of the output devices 38 and one or more of the input devices 40. The internal components 30 can further include a component interface 42 to provide a direct connection to auxiliary components or accessories for additional or enhanced functionality. The internal components 30 preferably also include a power supply 44, such as a battery, for providing power to the other internal components while enabling the overall cellular telephone to be portable.

In accordance with embodiments of the present invention in which the cellular telephone 4 is capable of both RF (or other electromagnetic) wireless communications and capacitive wireless communications, the wireless transceivers 35 include both at least one transceiver allowing for RF wireless communications and at least one transceiver allowing for capacitive wireless communications. In the particular embodiment of FIG. 2, the wireless transceivers 35 include, in addition to a capacitive wireless transceiver 33, two distinct RF wireless transceivers, namely, a cellular RF wireless transceiver 31 and a personal area network (PAN) RF wireless transceiver 32. The cellular RF wireless transceiver 31 allows for conventional RF wireless communications between the cellular telephone 4 and another cellular device such as a base station/cell tower (not shown), while it is the PAN RF wireless transceiver 32 that allows for communication with other wireless communication devices that are located within a short range such as the particular other devices 6, 8 and 10 shown in FIG. 1. Thus, in the present embodiment, it is the PAN RF wireless transceiver 32 that allows the cellular telephone 4 to communicate with the devices 6, 8 and 10 via the RF wireless communication network 14 of FIG. 1.

In the embodiment of FIG. 2, the cellular RF wireless transceiver 31 can be configured for allowing communications in accordance with any of a variety of cellular wireless communication protocols including, for example, CDMA, CDMA2000 and GSM, among others. The PAN RF wireless transceiver 32 can be configured for allowing communications in accordance with any of a variety of PAN wireless communication protocols such as Bluetooth, Zigbee, or ultra-wideband protocols. In alternate embodiments, the RF wireless transceiver 32 need not be specifically a PAN RF wireless transceiver. The capacitive wireless transceiver 33 can be configured for communications in accordance with any of a variety of capacitive communication protocols including Skinplex as described above.

The internal components 30 can operate independently and in conjunction with one another to perform a number of functions. For example, upon receiving wireless signals, the internal components 30 detect communication signals and the transceivers 35 in particular are capable of demodulating the communication signals to recover incoming information, such as voice data and/or other data, transmitted by the wireless signals. After receiving the incoming information from one or more of the transceivers 35, the processor 34 formats the incoming information for the one or more output devices 38 and/or for storage in the memory portion 36. Similarly, for transmission of wireless signals, the processor 34 formats outgoing information, which can (but need not) be activated by the input devices 40, and conveys the outgoing information to one or more of the transceivers 35 for modulation to communication signals.

Further as shown in FIG. 2, the input and output devices 3 8, 40 of the internal components 30 can include a variety of types of visual, audio and/or mechanical input and output devices. For example, the output device(s) 38 can include a visual output device 46 such as a liquid crystal display or a light emitting diode indicator, an audio output device 48 such as a speaker, alarm and/or buzzer, and/or a mechanical output device 50 such as a vibrating mechanism. Likewise, by example, the input devices 40 can include a visual input device 52 such as an optical sensor (for example, a camera), an audio input device 54 such as a microphone, and a mechanical input device 56 such as a flip sensor, keyboard, keypad, selection button, touch pad, touch screen, capacitive sensor, motion sensor, and switch.

Actions that actuate one or more of the input devices 40 can include, but are not limited to, opening of the cellular telephone, unlocking the phone, moving the phone to actuate a motion, moving the phone to actuate a location positioning system, pressing of a button on the phone, and operating the phone. Additionally as shown in FIG. 2, the internal components 30 can also include a location circuit 58. Examples of the location circuit 58 include, but are not limited to, a Global Positioning System (GPS) receiver, a triangulation receiver, an accelerometer, a gyroscope, or any other information-collecting device that can identify a current location of the cellular telephone 4 (or of one or more of its internal components 30).

The memory portion 36 of the internal components 30 can include any number of a variety of different types of memory devices such as random access memory (RAM) devices, and can be used to store and retrieve data. Typically, although not necessarily, operation of the memory portion 36 in storing and retrieving data is governed by commands from the processor 34. The data that is stored by the memory portion 36 can include, but need not be limited to, operating systems (or other systems software), applications, and data. Each operating system in particular includes executable code that controls basic functions of the cellular telephone 4, such as interaction among the various internal components 30, communication with external devices via the transceivers 35 and/or the component interface 42, and storage and retrieval of applications and data to and from the memory portion 36.

As for the applications, each application includes executable code that operates in conjunction with the operating system to provide more specific functionality for the cellular telephone 4, such as file system service and handling of protected and unprotected data stored in the memory portion 36. Exemplary applications can include, for example, a discovery application for discovering media on behalf of a user and his/her phone and a download user agent responsible for downloading the media object described by the download descriptor. As for the data that is potentially stored in the memory portion 36, such data can include, for example, non-executable code or information that can be referenced and/or manipulated by an operating system or application for performing functions of the cellular telephone 4. Further for example, the data can include files having data with any of a variety of formats, purposes, types or uses including, for example, audio files, photographic or image files, text files, or other data files.

Turning to FIGS. 3 and 4, in accordance with at least some embodiments of the present invention, one or more (typically, each) of the dual mode wireless communication devices in a system such as the system 2 of FIG. 1 (e.g., the devices 4, 6 and 8) operates in a manner such that the device switches between RF wireless communications (e.g., via the RF wireless communication network 14) and capacitive wireless communications (e.g., via the capacitive wireless communication network 16). In some such embodiments, including the embodiments of FIGS. 3 and 4, the device more particularly operates in a capacitive mode of operation involving the capacitive wireless communication network 16 normally, but then at certain other times switches to a RF mode of operation involving the RF wireless communication network 14. By operating normally in the capacitive mode, and only operating in the RF mode at times where it is appropriate or necessary, power dissipation in the device (as well as the system of devices) is reduced.

In particular with reference to FIG. 3, upon starting operation at a step 60, the wireless communication device enters a normal, capacitive communication mode in which the device conducts communications via the capacitive wireless communication network 16 at a step 62. The wireless communication device continues to operate in this normal operational mode until such time as the capacitive wireless communication network 16 fails or is interrupted, at a step 64. The capacitive wireless communication network 16 can fail for any of a variety of reasons including, for example, when the person holding the wireless device or with respect to whom the wireless device is in proximity sets down the device or otherwise moves away from the device such that the capacitive link is no longer maintainable. When a failure or interruption occurs, the device switches to an alternate, RF communication mode in which the device conducts (or attempts to conduct) communications via the RF wireless communication network 14. This can involve “turning on” the appropriate RF wireless transceiver of the device (e.g., the transceiver 32 of FIG. 2), as indicated by step 66. Thus, subsequently, as shown in step 68, the device is communicating by way of the RF wireless communication network 14.

While the RF wireless communication network 14 is operational at step 68, the wireless device continues to determine whether the capacitive wireless communication network 16 is again in service. Once the capacitive wireless communication network 16 is reestablished at a step 70, the wireless communication device then proceeds to communicate by way of that network and discontinues communication via the RF wireless communication network 14. Thus the RF wireless transceiver is turned off at a step 72 and the device returns to its normal, capacitive mode of operation at the step 62. Although in the present embodiment it is the capacitive communication mode of operation that is the normal mode of operation and it is the RF mode of operation that is the alternate (non-normal) mode of operation, in alternate embodiments, this need not be the case. For example, in some alternate embodiments, once the wireless communication device begins communicating via the RF wireless communication network 14, it will remain in the RF mode until such time as there is a failure in the RF wireless communication network. In further alternate embodiments, the RF mode can be the normal mode of operation and the capacitive mode could be the alternate mode of operation. In still additional embodiments, the wireless device can be capable of operating in three (or even more) modes, with two or more of the modes being different RF (or other electromagnetic communication) modes (e.g., cellular vs. PAN) or even different capacitive modes.

Turning to FIG. 4, in additional embodiments of the invention, the wireless communication device (e.g., the cellular telephone 4) not only switches from a capacitive mode to a RF mode when the capacitive wireless communication network 16 fails, but also switches between those modes when an event occurs that renders the capacitive mode inadequate for the communication purpose. More specifically, as shown in FIG. 4, upon starting operation at a step 74, the wireless communication device enters a normal capacitive mode of communications, in which the wireless device communicates via the capacitive wireless communication network 16, at a step 76. Next, at a step 78, an event occurs that renders the capacitive wireless communication network 16 inadequate for the desired communications. For example, as shown in step 78, the wireless device can intend to transmit voice or even image data that is of sufficient volume that the data rate of the capacitive wireless communication network 16 is inadequate for transmitting the data and the higher data rate of the RF wireless communication network 14 is appropriate. Also for example, the quality of the service provided by the capacitive wireless communication network might be become inadequate due to noise or for some other reason.

When such an event occurs, the wireless device turns on its RF transceiver (e.g., the transceiver 32 of FIG. 2) at a step 80 and then begins communicating via the RF wireless communication network 14, at a step 82. So long as the higher data rate of the RF wireless communication network 14 is required, that network remains operational as indicated by step 82. However, once the need for the data rate of the RF wireless communication network 14 expires, at a step 84, the RF transceiver is then turned off at a step 86 and the wireless device reverts to communication via the capacitive wireless communication network 16, thus returning to step 76. Therefore, by following this set of operational steps, the wireless device further minimizes power dissipation by limiting operation of the wireless device in the RF mode to those circumstances in which communication via the RF wireless communication network 14 is necessary, or at least preferable, to communication via the capacitive communication network 16. It should further be noted that, while in some embodiments the wireless device would switch to the RF mode in both of the circumstances shown in FIGS. 3 and 4, in other embodiments the wireless device would only switch in one of those circumstances.

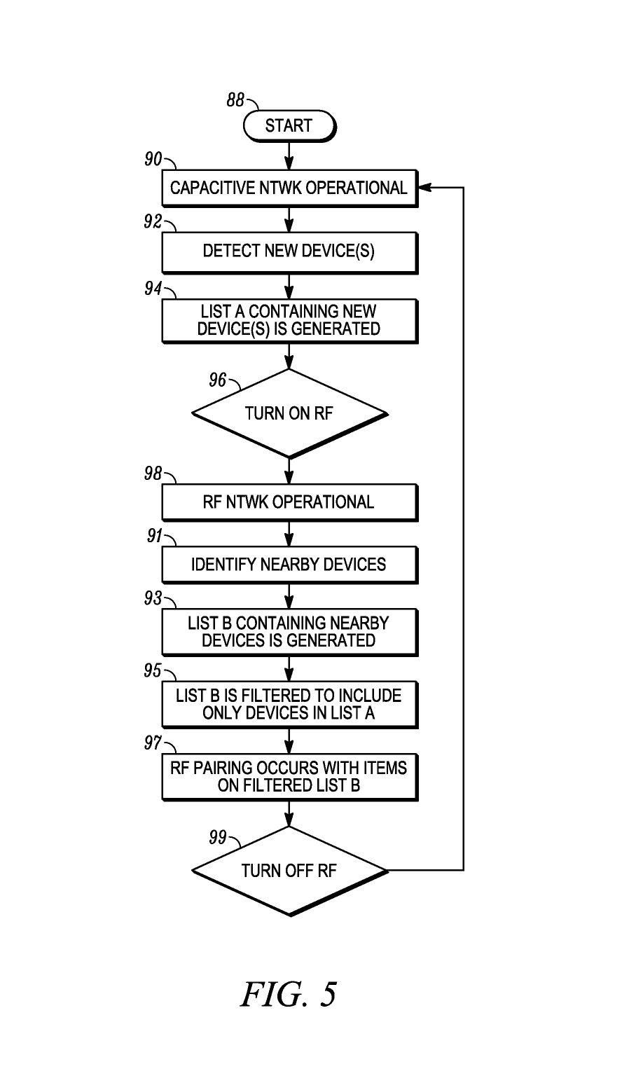

Turning to FIG. 5, the wireless communication device, by way of its dual mode operational capability, in at least some embodiments is further able to operate in a manner in which it identifies a subset of wireless communication devices from a larger set of other wireless communication devices. More particularly, the wireless communication device determines a subset of other wireless communication devices that are not only capable of communicating via the RF wireless communication network 14 but also are capable of communicating via the capacitive wireless communication network 16. Such operation can be desirable in various circumstances including, for example, circumstances where a given wireless communication device is in the possession of a first person who not only is in possession of one or more other wireless devices but also is in a crowd of other people who are themselves in possession of further wireless devices, all of which are potentially capable of communicating by way of the RF wireless communication network 14 with the given wireless communication device of the first person. By determining a subset of the other devices that are capable of communicating both by way of the RF wireless communication network 14 and by way of the capacitive wireless communication network 16, the given wireless communication device of the first person is able to identify those of the other wireless devices that are in the possession of (e.g., carried by or at least within close proximity of) the first person.

More particularly as shown in FIG. 5, the given wireless communication device of the first person, which can be the cellular telephone 4 of FIG. 1, after starting operation at a step 88 operates so as to be in communication via the capacitive wireless communication network 16, as indicated by step 90. Over time, the wireless communication device detects various other wireless devices that are capable of communication via the capacitive communication network 16 as those devices also enter into communication via the network, as represented by step 92. These are devices that are in contact with, or at least in close proximity to, the first person (e.g., devices 6 and 8 of FIG. 1). Further, as indicated by a step 94, as the given wireless communication device detects the presence of these other wireless devices via the capacitive communication network 16, the given wireless communication device generates a list A of those detected devices.

Further as shown, at some time, the given wireless communication device enters into communications via the RF wireless communication network 14. As indicated by a step 96, this can occur when a transceiver such as the PAN RF transceiver 32 of FIG. 2 is turned on. As a result, the RF wireless communication network 14 is operational as shown at a step 98. Once the given wireless communication device begins communicating via the RF wireless communication network 14, it identifies other wireless devices that are in communication via that network, as indicated by a step 91. To the extent that the RF wireless communication network 14 in the present embodiment is a PAN, this operation serves to identify wireless communications devices that are physically proximate to the first wireless communications device. These could include, for example, each of the devices 6, 8 and 10 of FIG. 1. Once the given wireless communication device detects and identifies the other wireless devices that are present and capable of communicating via the RF wireless communication network 14, the given wireless communication device generates a list B of those identified devices, at a step 93.

By virtue of the information received from the other identified wireless devices, the given wireless communication device is capable of determining correspondences between the devices in the list B that are capable of RF communication and the devices in the list A that are capable of capacitive communication. Upon such correspondences, the given wireless communication device then generates a filtered version of the list B that includes only those of the other wireless devices that are capable of communicating via both the RF wireless communication network 14 and the capacitive wireless communication network 16, that is, those of the devices in list B that have a corresponding entry in list A, at a step 95. The filtered version of the list B is then used, at a step 97, by the given wireless communication device to restrict its interaction with other wireless devices via the RF wireless communication network 14.

That is, at step 97, RF pairing by the given wireless communication device only occurs with the items on the filtered list B, and thus the given wireless communication device only interacts via the RF wireless communication network 14 with those other wireless devices that are also capable of communicating via the capacitive wireless communication network 14. Since RF communication is restricted to those devices that are capable of communicating via the capacitive wireless communication network, RF communications by the given wireless communication device thus are typically restricted to only those devices that are in the possession of the same, first person who is in possession of the given wireless communication device. For example, in the system of FIG. 1, the cellular phone 4 will restrict its communications via the network 14 to the headset 6 and wrist wearable communication device 8, and not communicate with the computer 10. Finally, at a subsequent time as indicated by a step 99, the RF transceiver is turned off (either for reasons such as those discussed above with reference to FIGS. 3 and 4 or for other reasons) and the given wireless communication device returns to the capacitive mode of operation at the step 90.

The present invention is intended to encompass many variations of the devices, systems and functionality described above. For example, it is also a possibility that the detection operation described with respect to FIG. 5 can allow for the given wireless communication device to instruct other wireless devices to turn off when they are no longer in communication via the capacitive wireless communication network 16. Further, in some embodiments, the ability to exchange information via the capacitive wireless communication network permits a RF link to be automatically established with no intervention from the user. That is, while typically a user must actively approve a wireless connection for each new device through a host device (e.g., the phone 4), in some embodiments of the present invention the capacitive communication capability of a device can be the determining factor as to whether that device is allowed to be in RF communications with another device such as the host device.

Additionally, in some embodiments, to avoid other devices being automatically being added when they come into contact with a user, a host device (such as the phone 4) can be set to different modes (e.g., accept all, accept only selected, or off). Thus, in a variety of manners, the present invention can provide a simple, intuitive mechanism for establishing desired, and sometimes restricted, communications among various wireless devices. Further, while the embodiment described above with respect to FIG. 5 envisions limiting the RF communications of a given device to those devices that are also capable of capacitive communications, in alternate embodiments the reverse could be the case, where the capacitive communications of a given device with respect to other devices was limited to those other devices that were also capable of RF communications. Also, while in the above-discussed embodiments it is envisioned that the body of a human being will serve as a medium for capacitive wireless signals, the present invention is also intended to encompass embodiments where some other living (e.g., a live animal) or inanimate object serves as a medium for capacitive wireless signals.

It is specifically intended that the present invention not be limited to the embodiments and illustrations contained herein, but include modified forms of those embodiments including portions of the embodiments and combinations of elements of different embodiments as come within the scope of the following claims.

We claim:

1. A first communication device configured for communications with a second communications device, the first communication device comprising:
a first transceiver allowing the first communication device to send and receive electromagnetic communication signals;
a second transceiver allowing the first communication device to send and receive capacitive communication signals; and
a control device coupled to the first and second transceivers,
whereby the first communication device is configured for achieving both electromagnetic communications and capacitive communications, respectively, with the second communication device.

2. The first communication device of claim 1, wherein the first communication device is capable of the capacitive communications with the second communication device when both of the devices are either in contact with a human body or positioned within a threshold distance of the human body.

3. The first communication device of claim 2, wherein the threshold distance is one meter, and wherein the first communication device additionally includes a memory device coupled to the control device, and the control device includes a microprocessor.

4. The first communication device of claim 1, wherein the electromagnetic communications is RF wireless communications in accordance with a protocol selected from the group consisting of a Bluetooth protocol, a ZigBee protocol, and an ultrawideband protocol.

5. The first communication device of claim 1, wherein the first communication device is selected from the group consisting of a cellular telephone, a wireless telephone, a stereo headset, a mono headset, a wrist wearable communications device, a communication device embedded within a garment, a personal computer, a keyboard, a keypad, a touchscreen, a pager, an eyeware display, and a handheld device.

6. A communication system comprising the first communication device of claim 1, the communication system additionally including the second communication device, wherein the first and second communication devices are in communication by way of both a RF wireless communication network and a capacitive communication network.

7. The communication system of claim 6, wherein each of the RF wireless communication network and the capacitive communication network is a personal area network.

8. The communication system of claim 6, further comprising a third communication device, the third communication device being capable of communicating with one or both of the first and second communication devices by way of one or both of the RF wireless communication network and the capacitive communication network.

9. The communication system of claim 8, wherein the third communication device is capable of communicating with both of the first and second communication devices by way of both the RF wireless communication network and the capacitive communication network.

10. The communication system of claim 6, wherein communication via the RF wireless communication network is limited to circumstances in which communication via the capacitive communication network is interrupted or is not possible, in which the capacitive communication network is incapable of providing sufficient bandwidth, or in which a quality of service provided by the capacitive communication network is inadequate,
whereby power dissipation associated with the communication via the RF wireless communication network is reduced.

11. A method of communicating comprising:
transmitting a capacitive communication signal from a first communication device to a second communication device; and
transmitting an electromagnetic communication signal from either the first communication device to the second communication device or from the second communication device to the first communication device,
wherein the transmitting of the capacitive communication signal precedes, occurs simultaneously with, or occurs after the transmitting of the electromagnetic communication signal.

12. The method of claim 11, wherein the capacitive communication signal is transmitted by way of a human body, and wherein the electromagnetic communication signal is a RF wireless communication signal.

13. The method of claim 11, further comprising:
determining that a capacitive communication link either has been interrupted or is incapable of supporting a desired data transmission rate,
wherein the electromagnetic communication signal is transmitted after the determining.

14. The method of claim 13, further comprising, subsequent to the transmitting of the electromagnetic communication signal:
establishing that the capacitive communication link has been restored, or that the desired data transmission rate is no longer desired or required; and
transmitting additional capacitive communication signals between the first and second communication devices.

15. The method of claim 13, wherein means for processing in the first communication device performs the determining, and wherein the means for processing causes the first communication device to operate normally in a capacitive communications mode such that a RF transceiver of the first communication device operates in a low-power mode or an off mode.

16. A method of operating a first communication device, the method comprising:
operating the first communication device in a first mode such that the first communication device is capable of conducting communications with a second communication device by way of a capacitive communication link; and
operating the first communication device in a second mode such that the first communication device is capable of conducting communications with the second communication device by way of a RF wireless communication link,
wherein the first communication device normally operates in the first mode so that a power dissipation associated with the operating in the second mode is limited.

17. The method of claim 16, wherein at least one of the following is true:
when the first communication device is operated in the second mode, the first communication device is also capable of conducting communications with the second communication device by way of the capacitive communication link; and
when the first communication device is operated in the second mode, the first communication device does not communicate with the second communication device by way of the capacitive communication link.

18. The method of claim 16, further comprising:
detecting one or more capacitive communication devices including the second communication device that are capable of communicating with the first communication device by way of a capacitive communication network that includes the capacitive communication link; and
detecting one or more RF wireless communication devices including the second communication device that are capable of communicating with the first communication device by way of a RF wireless communication network that includes the RF wireless link.

19. The method of claim 18, further comprising:
determining which of the detected RF wireless communication devices are among the detected capacitive communication devices; and
generating a device correspondence list including the detected capacitive communication devices and those of the detected RF wireless communication devices that were determined as being among the detected capacitive communication devices,
wherein the device correspondence list pairs the respective detected capacitive communication devices with the corresponding respective detected RF wireless communication devices.

20. The method of claim 16, wherein the first communication device switches from the first mode to the second mode when the first communication device determines that the capacitive communication link has experienced a failure or an amount of bandwidth greater than that provided by way of the capacitive communication link is required.
